(19) United States
(12) Patent Application Publication
(10) Pub. No.: US 2026/0064778 A1
(43) Pub. Date: Mar. 5, 2026

(54) CUSTOMIZABLE DOCUMENT PROCESSING AND RETRIEVAL SYSTEM FOR ENHANCED ARTIFICIAL INTELLIGENCE RESPONSES

(71) Applicant: Micro Focus LLC, Wilmington, DE (US)

(72) Inventors: Wen Lin, Shanghai (CN); Hao Liu, Shanghai (CN); Bing Zhang, Shanghai (CN)

(73) Assignee: Micro Focus LLC, Wilmington, DE (US)

(21) Appl. No.: 18/822,575

(22) Filed: Sep. 3, 2024

(51) Int. Cl. G06F 16/93; G06N 3/08

(52) U.S. Cl. CPC G06F 16/93; G06N 3/08

(57) ABSTRACT

Systems and methods are provided to execute chunking of documents in accordance with a resolver selected in accordance with one or more document elements of the document. A server or other computing device then chunks the document, which may be initially chunked in accordance with static rules, and re-chunked to maintain logical associations and meanings between the otherwise separate chunks.

### FIELD OF THE DISCLOSURE

The invention relates generally to systems and methods for automatically chunking documents and particularly to developing and utilizing resolvers to dynamically configure the chunking of a document.

### BACKGROUND

Certain prior art artificial intelligent (AI) systems utilize Retrieval-Augmented Generation (RAG) to enhance results from large language models (LLMs) by retrieving relevant documents as the knowledge context to improve the quality of generated answers. However, prior RAG solutions often rely on text splitting techniques that either monotonously split large data into equal-sized chunks, use character separators (e.g., \n, “ ”, etc.) to divide the text, or use embedding models and algorithms for more complex splitting.

Prior art RAG solutions often use the following methods to split large data into smaller chunks:

Size-based splitting: This method splits the document into chunks based on a predetermined size, such as a specific number of characters or words (e.g., 500 tokens). While straightforward, this approach does not account for the semantic coherence of the chunks, potentially breaking up meaningful sections of text.

Paragraph-based splitting: In this approach, the document is split into chunks based on paragraph boundaries. This method maintains the logical structure of the text to some extent but may still result in chunks that vary significantly in length and may not always align with meaningful sections of content.

Recursive Character Text Splitting: This technique recursively splits the document at character separators (e.g., \n\n, \n, or “ ”) until the chunks are of an acceptable size. While this method ensures chunks are manageable in size, it often disregards the context and meaning of the text, leading to fragmented and less coherent chunks.

Document Specific Splitting: This method uses different splitters for different file formats (e.g., PDF splitter, Python splitter, markdown splitter). This approach effectively handles the unique characteristics of various file types, allowing for more appropriate special character recognition. However, it does not enhance semantic relevance and may not account for internal variations within the same format. For example, an IT report and a financial report in same PDF format might require different splitting strategies due to their differing internal content structures.

Semantic Chunking: This advanced technique uses natural language processing (NLP) to split the document into chunks based on semantic meaning. It aims to group related sentences or paragraphs together, preserving the coherence and context of the text. However, the effectiveness of semantic chunking depends on the accuracy of the NLP models used and may still miss domain-specific understandings without inputting from knowledgeable administrators.

### SUMMARY

While the prior art provides certain advantages, deficiencies and opportunities to advance the state of the art remain. The prior art systems do not allow the customers' knowledge administrators to participate in the text splitting and embedding processes, which limits the system's ability to leverage the administrators' domain-specific knowledge. This results in suboptimal query responses, as the AI system cannot fully utilize the administrators' expertise in structuring and understanding their documents.

These and other needs are addressed by the various embodiments and configurations of the present invention. The present invention can provide a number of advantages depending on the particular configuration. These and other advantages will be apparent from the disclosure of the invention(s) contained herein.

Improvements to the state of the art are provided by the embodiments described herein. Improvements include one or more of:
Enhanced Accuracy: By allowing knowledge administrators to define document structures, semantics, intents, and prompt templates, this system leverages the administrators'domain-specific knowledge to improve the accuracy and relevance of the generated answers;
User Empowerment: Knowledge administrators can directly influence the knowledge processing steps without needing programming skills, making this system more user-friendly and customizable;
Domain-Specific Customization: This system accommodates various document types and structures, ensuring that the unique characteristics of different domains are properly handled; and
Improved Retrieval: Matching user queries to predefined intents allows for more precise retrieval of relevant document chunks, enhancing the overall quality of the response.

In some aspects, the techniques described herein relate to a method of vectorizing a document, including: chunking the document, in accordance with a resolver, into a number of chunks, wherein the resolver defines associations for portions of a documents type that include the document; vectorizing the number of chunks into a number of vectorized chunks; and storing the number of vectorized chunks.

In some aspects, the techniques described herein relate to a method, wherein chunking the document, in accordance with the resolver, into the number of chunks includes: matching a first document element of the document to a first document element identifier; matching a second document element of the document to a second document element identifier; and upon an association rule determining the first document element identifier is associated with the second document element identifier, chunking the first document element and the second document element into a single chunk of the number of chunks.

In some aspects, the techniques described herein relate to a method, wherein at least one of the first document element identifier and the second document element identifier are determined in accordance with a file type of the document.

In some aspects, the techniques described herein relate to a method, wherein at least one of the first document element identifier and the second document element identifier are determined in accordance with a domain of the document.

In some aspects, the techniques described herein relate to a method, wherein the association rule is selected from a plurality of association rules in accordance with a user-provided intent of the document, and wherein the user-provided intent includes an association between a number of association rules including the association rule.

In some aspects, the techniques described herein relate to a method, wherein the number of chunks is selected in accordance with a maximum chunk size for each of the number of chunks.

In some aspects, the techniques described herein relate to a method, further including selecting the resolver from a plurality of resolvers, the selection further including providing the resolver to an artificial intelligence trained to analyze the document and determine therefrom a closest matching resolver, wherein the artificial intelligence is trained to analyze the document including at least one of determining a closest domain and a file type.

In some aspects, the techniques described herein relate to a system, including: a network interface to a communication network; and a microprocessor coupled to a computer memory including machine-readable instructions that when read by the microprocessor cause the microprocessor to perform: accessing a document; accessing a resolver; chunking the document, in accordance with the resolver, into a number of chunks; vectorizing the number of chunks into a number of vectorized chunks; and providing, via the network interface, the number of vectorized chunks to a data storage for storage therein.

In some aspects, the techniques described herein relate to a system, wherein the number of chunks is selected in accordance with a maximum chunk size for each of the number of chunks.

In some aspects, the techniques described herein relate to a system, wherein the microprocessor further performs selecting the resolver from a plurality of resolvers, the selection further including providing the resolver to an artificial intelligence trained to analyze the document and determine therefrom a closest matching resolver, wherein the artificial intelligence is trained to analyze the document including at least one of determining a closest domain and a file type.

In some aspects, the techniques described herein relate to a system, wherein the microprocessor performs chunking the document, in accordance with the resolver, into the number of chunks, further including: matching a first document element of the document to a first document element identifier; matching a second document element of the document to a second document element identifier; and upon an association rule determining the first document element identifier is associated with the second document element identifier, chunking the first document element and the second document element into a single chunk of the number of chunks.

In some aspects, the techniques described herein relate to a system, wherein at least one of the first document element identifier and the second document element identifier are determined in accordance with a file type of the document.

In some aspects, the techniques described herein relate to a system, wherein at least one of the first document element identifier and the second document element identifier are determined in accordance with a domain of the document.

In some aspects, the techniques described herein relate to a system, wherein the association rule is selected from a plurality of association rules in accordance with a user-provided intent of the document, and wherein the user-provided intent includes an association between a number of association rules including the association rule.

In some aspects, the techniques described herein relate to a system, further including: a user interface; and wherein the microprocessor further performs: receiving user inputs via the user interface to construct a template, wherein the template associates at least one of a first training document element to the first document element identifier or a second training document element to the second document element identifier; and storing the template as the resolver.

In some aspects, the techniques described herein relate to a system, further including receiving a user input including an intention.

In some aspects, the techniques described herein relate to a system, wherein the microprocessor further performs: receiving a query via the user interface; and matching the query to the intention and, in response, appending the number of vectorized chunks associated with the single chunk.

In some aspects, the techniques described herein relate to a system, wherein the microprocessor further performs: receiving a query via the user interface; and failing to match the query to the intention and, in response, appending the number of vectorized chunks associated with at least one of a content vector or a semantic vector.

In some aspects, the techniques described herein relate to a system, wherein the microprocessor further performs: retrieving the number of vectorized chunks; receiving a query; appending the number of vectorized chunks to the query; and providing the query to a large language model and receiving a response therefrom.

In some aspects, the techniques described herein relate to a computer-readable media including instructions that, when read by a microprocessor, cause the microprocessor to perform: accessing a document; accessing a resolver; chunking the document, in accordance with the resolver, into a number of chunks; vectorizing the chunks into a number of vectorized chunks; and providing the number of vectorized chunks to a data storage for storage therein.

A system on a chip (SoC) including any one or more of the above aspects or aspects of the embodiments described herein.

One or more means for performing any one or more of the above or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects or aspects of the embodiments described herein, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.” Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a document in accordance with embodiments of the present disclosure;

FIG. 3 depicts a process in accordance with embodiments of the present disclosure;

FIG. 4 depicts a process in accordance with embodiments of the present disclosure;

FIG. 5 depicts a process in accordance with embodiments of the present disclosure; and

FIG. 6 depicts a device in a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

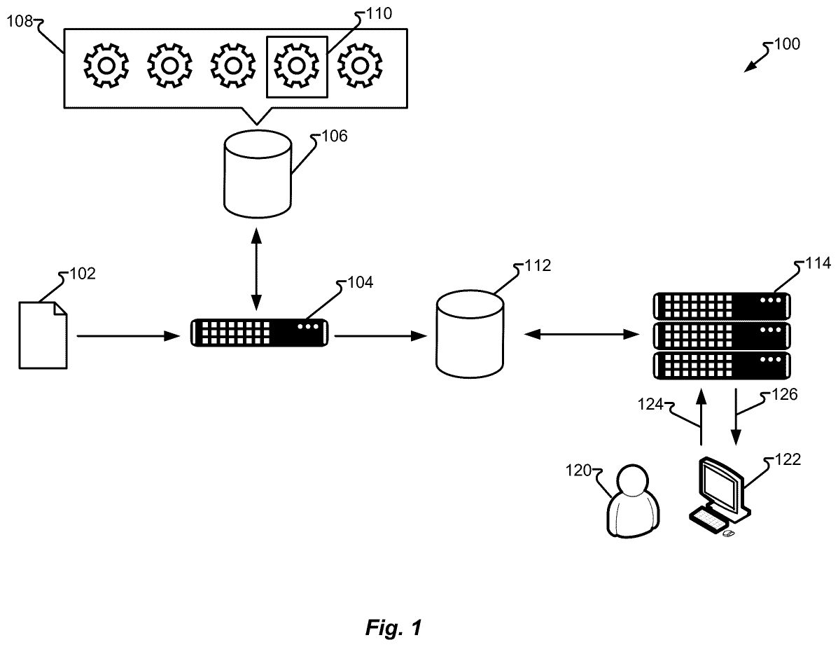

FIG. 1 illustrates system 100 in accordance with embodiments of the present disclosure. In one embodiment, system 100 illustrates components comprising computing components 104, 114, 122, and data storage components (e.g., database 106, vector database 112) interconnected, such as via a network. It should be appreciated that, in one embodiment, each of the illustrated components provides a single service. However, one of ordinary skill in the art will recognize that other topologies may be deployed without departing from the scope of embodiments herein. For example, any one component may be embodied as a plurality of components and/or any two or more components may be embodied as a single component. In one embodiment, the components as illustrated perform a single function; in other embodiments, one or more components may perform a plurality of functions and/or one or more functions may be performed by a plurality of components including as a service (e.g., software as a service (SaaS)). In yet another embodiment, the connection topology may be the topology as illustrated in system 100, or another topology without departing from the scope of the embodiments.

Document 102 is variously embodied and includes, but is not limited to, word processing documents (e.g., .DOC, .DOCX, .PDF, etc.), spreadsheet documents (e.g., .XLS, etc.), presentations (e.g., .PPT, etc.), audio files (e.g., .WAV, etc.), video files (e.g., .MP4, etc.), still images (e.g., .JPG, .BMP, .PNP, etc.), etc. Document 102 may be in electronic form or physical form (e.g., a book, magazine, newspaper, photograph, etc.) and digitized for accessing and processing by server 104. As a further option, audio content may be transcribed with an automated speech-to-text and video/image content processed with an optical character recognition (OCR) process and/or image recognition application to identify words spoken or displayed and/or persons or items imaged.

In another embodiment, server 104 chunks document 102. Chunking is a known process wherein a document is parsed into components for storage in a vector database, such as vector database 112, for use by a large language model (LLM) or other artificial intelligence, such as LLM 114. How document 102 is chunked may have a significant effect on the performance and usability of LLM 114 to answer a query. In the prior art, documents are chunked based on static limitations, such as number of words, tokens, characters, etc., and optionally on sections (e.g., title, page breaks, paragraph breaks, etc.). However, prior art systems treat all text the same. For example, a heading of a graph may be treated as having the same importance as words in the middle of a paragraph. As a result, key aspects of a document may be lost among the more mundane aspects and an LLM may provide erroneous or incomplete information (e.g., hallucinations). Embodiments herein address these shortcomings to, among other things, determine and maintain the association of document content to maintain the meaning, intentions, and/or semantics vectorized into the vectorized chunks used by LLM 114.

Document 102 is accessed, or provided to, server 104, which chunks the document into a number of chunks. The chunks are then vectorized for storage in vector database 112. In one embodiment, server 104 performs an initial chunking of document 102, such as by segmenting document 102 into a number of chunks wherein none are larger than a threshold chunk size. Additionally or alternatively, server 104 may chunk document 102 in accordance with a resolver, such as resolver 110 selected from a set of resolvers 108 maintained in database 106.

The selection of the particular resolver (i.e., resolver 110) from the set of resolvers 108 is based, in one embodiment, on the file type of document 102. For example, if document 102 is a spreadsheet, resolver 110 is selected as being associated with spreadsheets. As a result, resolver 110 may chunk document 102 in accordance with spreadsheets. For example, numbers in cells of the spreadsheet may be maintained with a column and/or row heading, proximity to other cells or cell values, association with a graph, etc. In another example, document 102 is a word processing document and resolver 110 is selected as being associated with word processing documents. As a result, resolver 110 may chunk document 102 in accordance with word processing documents.

For example, chunks may maintain an association with a chapter title, proximity to a graphical element (e.g., a chart, photo, etc.), or other aspect of word processing documents. The type of document and portions of the content are examples of document elements. The content of document 102 (e.g., a graphical element, text, a heading, a title, etc.) may be determined from an initial chunking. The document elements are then re-associated to form a new chunk. For example, a value in a cell of a spreadsheet (one element) is associated with column heading and/or row heading (a second/third element). The resulting elements are then combined as a chunk for storage in vector database 112.

In another embodiment, the selection of resolver 110 from the set of resolvers 108 is based on a domain or subject matter of document 102. For example, if document 102 is determined to be a technical support document, then resolver 110 is selected as being associated with the technical support domain. As a result, document 102 is chunked in accordance with technical support documentation. For example, identification of the affected hardware for a particular issue may be maintained throughout a diagnostic and/or resolution portion of document 102. As a result, diagnosing and/or resolving the issue is maintained in a chunk associated with the specific hardware affected.

In another embodiment, resolver 110 may be two or more resolvers from a set of resolvers 108 and may be utilized by server 104 to chunk document 102. For example, a spreadsheet resolver may associate document 102 elements for spreadsheets (e.g., cell values with their corresponding column/row heading) and a technical support resolver, such as to maintain affected hardware with listed diagnostic/resolution steps.

In another embodiment, user 120 utilizing computer 122 may issue query 124 to LLM 114 and receive response 126 therefrom. As a result of certain embodiments herein, LLM 114 accesses vectorized chunks maintained in vector database 112 having more complete context. Additionally or alternatively, query 124 may be directed to or incorporate server 104, such as to identify the resolver (e.g., resolver 110) and/or attributes thereof, which may be provided as another document element to LLM 114. As a result, the chunks evaluated to generate response 126 are more complete and more likely to be accurate and focused than what would likely result with LLM 114 accessing chunks of document 102 that are merely statically chunked. As a further embodiment, document elements may be associated with an identifier and matched, such as to portions of query 124. For example, if query 124 is looking to resolve a technical issue on a particular hardware, the hardware element of the query may be identified and matched to one or more chunks by LLM 114

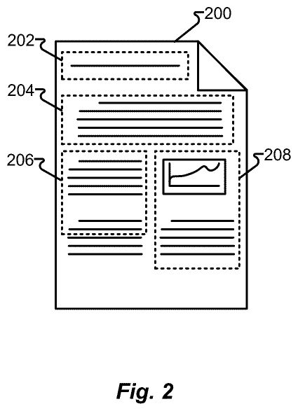

FIG. 2 depicts document 200 in accordance with embodiments of the present disclosure. In one embodiment, document 200 is a word processing document and one example of document 102. Document 200 may be initially chunked based on static rules (e.g., number of characters, words, or tokens; portions before or after a title, paragraph, or section; etc.). For example, title chunk 202 may include a title, abstract chunk 204 may include a summary or abstract, detail chunk 206 may include detailed descriptions, and graphic chunk 208 may be associated with a graph and/or description of the graph. A resolver may be applied such as to identify document elements of document 200 and combine related portions, such as title chunk 202 with each other chunk (e.g., chunks 204, 206, and 208). As a result, two or more initial chunks may be combined and vectorized for storage in a vector database (e.g., vector database 112).

In another embodiment, a resolver may segregate one chunk into two or more. For example, document 200 may be a technical support document and a graph, such as a graph converted to text and chunked as a portion of graphic chunk 208, or document 200 may be a graph showing the number of occurrences for a particular issue over time. Such information may have limited value in diagnosing or resolving a technical support issue. Accordingly, a technical support resolver (e.g., resolver 110) may re-chunk graphic chunk 208 into two or more chunks, such as a textual description of the occurrence over time and the remaining text (e.g., diagnostics, resolutions, etc.)

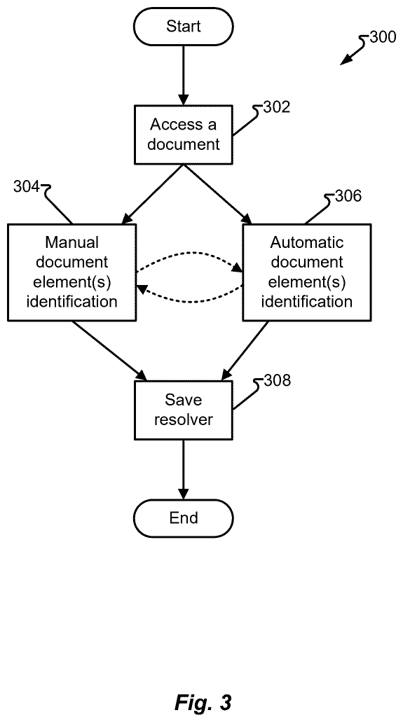

FIG. 3 depicts process 300 in accordance with embodiments of the present disclosure. Process 300 is generally directed to creating a resolver (e.g., resolver 110). In one embodiment, process 300 is embodied as machine-readable instructions maintained in a non-transitory memory that when read by a machine, such as one or more processors of a server or servers, cause the machine to execute the instructions and thereby execute process 300. The processor of the server may include, but is not limited to, at least one processor of server 104 and/or other computing device.

Process 300 begins and, at step 302, a document is accessed. Step 304 receives manual document element identification, such as a user utilizing a computer (e.g., user 120 using computer 122). The document may be segmented into intentions, sentiments, and/or other document elements as determined by a manual operator. Step 306, while functionally similar to step 304, automatically performs an analysis on the document to identify one or more elements. For example, data mining or unsupervised AI may be provided with the document to determine what the document is (e.g., a domain), document type (e.g., a spreadsheet, an image, a word processing file, etc.), and/or elements of the document (e.g., a problem, a solution, topics, etc.).

Step 304 may be performed alone or step 306 may be performed alone. Additionally or alternatively, step 304 may be performed after step 306 and/or vice versa. For example, step 306 may determine certain elements of the document (e.g., file type, domain, etc.) and, with the benefit of such information, a particular user is selected and/or the user is provided with the certain elements to assist the user. For example, step 306 may determine that the document is an insurance document and select a user to perform step 304 that is known to be an insurance expert and/or prompt the user, such as with a template, for insurance related content (e.g., what is the limit of coverage, what is the premium, what are the exclusions, etc.). Alternatively, step 304 may be performed, such as to determine certain elements (e.g., a subject matter or domain) which is then provided to a computer/server to perform step 306, such as identify the document elements relevant for that particular domain. Steps 304 and/or 306 may then determine intents, purposes, and/or other elements of the document. As a further option, such elements may be identified and/or characterized so that an AI may determine a match in another document that is non-identical but sufficiently similar to a corresponding document element of the document accessed in step 302.

As a result, for the document accessed in step 302, chunks are known, whether or not such chunks are later vectorized. However, the methodology to perform the chunking is now known and, in step 308, saved as a resolver such as in database 106. Subsequent encounters with a similar document may then be analyzed to determine the appropriate resolver and/or used to chunk the similar document.

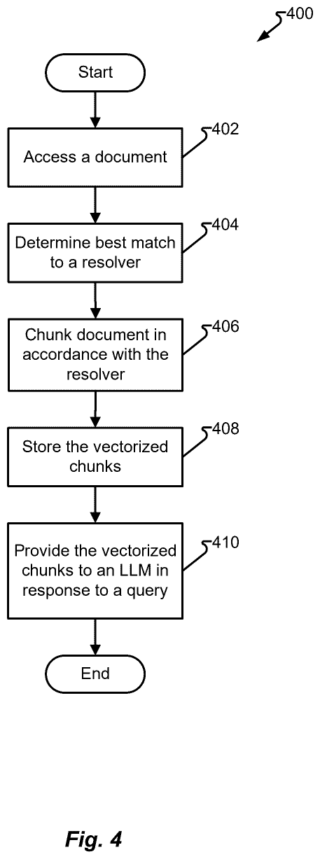

FIG. 4 depicts a process in accordance with embodiments of the present disclosure. In one embodiment, process 400 is embodied as machine-readable instructions maintained in a non-transitory memory that when read by a machine, such as one or more processors of a server or servers, cause the machine to execute the instructions and thereby execute process 400. The processor of the server may include, but is not limited to, at least one processor of server 104 and/or other computing device.

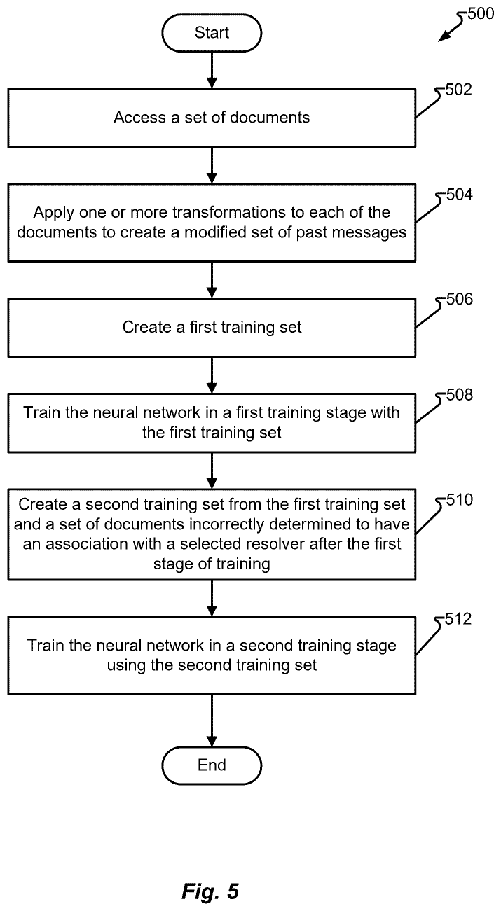

In one embodiment, process 400 begins and, in step 402, accesses a document. Step 404 determines a best match of the document, or portions thereof, to a resolver of a set of resolvers (e.g., resolver 110 from a set of resolvers 108). Determining a best match is variously embodied. In one embodiment, an AI agent trained to match documents with resolvers (see FIG. 5) is provided with the document and returns a best-match resolver. In another embodiment, the resolver is solely determined on domain (e.g., technical support, medical, etc.) and the content of the document is analyzed (e.g., an AI agent, pattern matching, dictionary, etc.) for key words, phrases, or other elements associated with the particular domain. For example, if the document described “error codes” and “dropped packets,” such terms may be readily associated with technical support documents and, therefore, matched to a technical support resolver. In contrast, if the document described “respiration” and “blood panel,” such terms may readily be associated with medical documents and, accordingly, a medical resolver selected. Resolvers may be selected, in whole or in part, based on the file or data type of the document. Additional resolvers may be provided and selected based on more granular information, such as a technical support document addressing a specific issue.

Step 406 then chunks the document in accordance with the selected resolver. The resulting chunks are then vectorized for storage in step 408. In step 410, the vectorized chunks are then provided to, or otherwise made available to, an LLM for processing queries and generating a response thereto.

FIG. 5 depicts process 500 in accordance with embodiments of the present disclosure. In one embodiment, process 500 is embodied as machine-readable instructions maintained in a non-transitory memory that when read by a machine, such as one or more processors of a server or servers, cause the machine to execute the instructions and thereby execute process 500. The processor of the server may include, but is not limited to, at least one processor of server 104 and/or other computing device.

A neural network, as is known in the art and in one embodiment, self-configures layers of logical nodes having an input and an output. If an output is below a self-determined threshold level, the output is omitted (i.e., the inputs are within the inactive response portion of a scale and provide no output). If the self-determined threshold level is above the threshold, an output is provided (i.e., the inputs are within the active response portion of a scale and provide an output). The particular placement of the active and inactive delineation is provided as a training step or steps. Multiple inputs into a node produce a multi-dimensional plane (e.g., hyperplane) to delineate a combination of inputs that are active or inactive.

Process 500 begins and, in step 502, a set of documents is accessed. The documents may be past or prior documents maintained in a data storage. The documents may be previously known and/or selected to be training documents. Step 504 then applies one or more transformations to the set of documents to create a modified set of documents. The transformations include one or more of adding content, removing content, rearranging content, adding section breaks, removing section breaks, adding an association with a selected resolver, and removing an association with a selected resolver. Step 506 then creates a first training set comprising the set of documents and the modified set of documents. Step 508 trains the neural network in a first training stage with the first training set. Step 510 creates a second training set from the first training set and a set of documents incorrectly determined to have an association with a selected resolver after the first stage of training. Step 512 trains the neural network in a second stage of training using the second training set.

As a result of training the neural network, a document may be provided to the trained neural network and an association with a particular resolver and/or the selection of a particular resolver received therefrom.

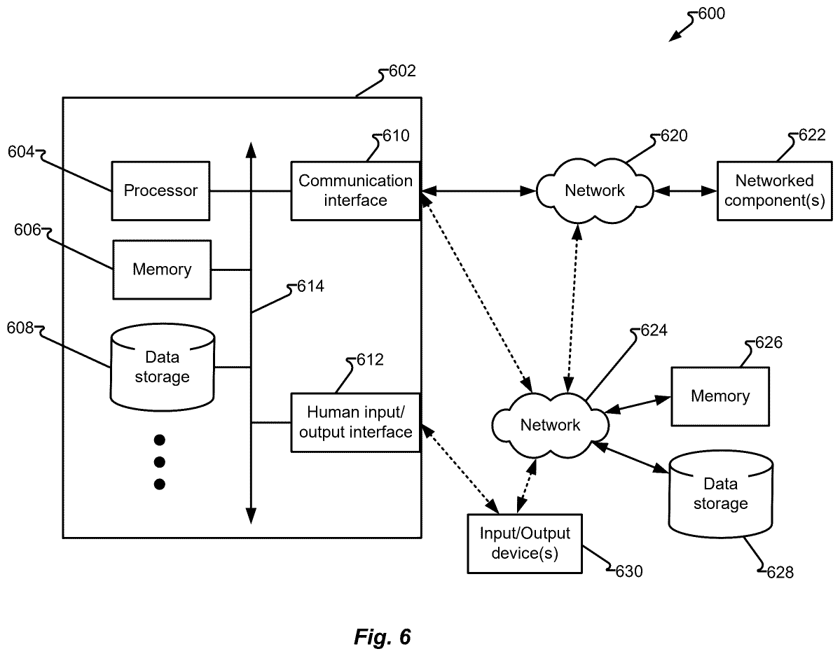

FIG. 6 depicts device 602 in system 600 in accordance with embodiments of the present disclosure. In one embodiment, server 104, LLM 114, and/or computer 122 may be embodied, in whole or in part, as device 602 comprising various components and connections to other components and/or systems. The components are variously embodied and may comprise processor 604. The term “processor,” as used herein, refers exclusively to electronic hardware components comprising electrical circuitry with connections (e.g., pin-outs) to convey encoded electrical signals to and from the electrical circuitry. Processor 604 may comprise programmable logic functionality, such as determined, at least in part, from accessing machine-readable instructions maintained in a non-transitory data storage, which may be embodied as circuitry, on-chip read-only memory, computer memory 606, data storage 608, etc., that cause the processor 604 to perform the steps of the instructions. Processor 604 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 614, executes instructions, and outputs data, again such as via bus 614. In other embodiments, processor 604 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 604 is a non-transitory computing device (e.g., electronic machine comprising circuitry and connections to communicate with other components and devices). Processor 604 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 604). Processor 604 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 604, device 602 may utilize computer memory 606 and/or data storage 608 for the storage of accessible data, such as instructions, values, etc. Communication interface 610 facilitates communication with components, such as processor 604 via bus 614 with components not accessible via bus 614 and may be embodied as a network interface (e.g., ethernet card, wireless networking components, USB port, etc.). Communication interface 610 may be embodied as a network port, card, cable, or other configured hardware device. Additionally or alternatively, human input/output interface 612 connects to one or more interface components to receive and/or present information (e.g., instructions, data, values, etc.) to and/or from a human and/or electronic device. Examples of input/output devices 630 that may be connected to input/output interface include, but are not limited to, keyboard, mouse, trackball, printers, displays, sensor, switch, relay, speaker, microphone, still and/or video camera, etc. In another embodiment, communication interface 610 may comprise, or be comprised by, human input/output interface 612. Communication interface 610 may be configured to communicate directly with a networked component or configured to utilize one or more networks, such as network 620 and/or network 624.

Network 620 may be a wired network (e.g., Ethernet), wireless (e.g., WiFi, Bluetooth, cellular, etc.) network, or combination thereof and enable device 602 to communicate with networked component(s) 622. In other embodiments, network 620 may be embodied, in whole or in part, as a telephony network (e.g., public switched telephone network (PSTN), private branch exchange (PBX), cellular telephony network, etc.).

Additionally or alternatively, one or more other networks may be utilized. For example, network 624 may represent a second network, which may facilitate communication with components utilized by device 602. For example, network 624 may be an internal network to a business entity or other organization, whereby components are trusted (or at least more so) than networked components 622, which may be connected to network 620 comprising a public network (e.g., Internet) that may not be as trusted.

Components attached to network 624 may include computer memory 626, data storage 628, input/output device(s) 630, and/or other components that may be accessible to processor 604. For example, computer memory 626 and/or data storage 628 may supplement or supplant computer memory 606 and/or data storage 608 entirely or for a particular task or purpose. As another example, computer memory 626 and/or data storage 628 may be an external data repository (e.g., server farm, array, “cloud,” etc.) and enable device 602, and/or other devices, to access data thereon. Similarly, input/output device(s) 630 may be accessed by processor 604 via human input/output interface 612 and/or via communication interface 610 either directly, via network 624, via network 620 alone (not shown), or via networks 624 and 620. Each of computer memory 606, data storage 608, computer memory 626, data storage 628 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 630 may be a router, a switch, a port, or other communication component such that a particular output of processor 604 enables (or disables) input/output device 630, which may be associated with network 620 and/or network 624, to allow (or disallow) communications between two or more nodes on network 620 and/or network 624. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMS, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core®i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

1. A method of vectorizing a document, comprising:
chunking the document, in accordance with a resolver, into a number of chunks, wherein the resolver defines associations for portions of a documents type that comprise the document, and
wherein the resolver comprises two or more different resolver types;
vectorizing the number of chunks into a number of vectorized chunks;
providing the number of vectorized chunks to a data storage for storage therein;
retrieving the number of vectorized chunks;
receiving a query;
appending the number of vectorized chunks to the query;
providing the query to a large language model; and
receiving a response therefrom.

2. The method of claim 1, wherein chunking the document, in accordance with the resolver, into the number of chunks comprises:
matching a first document element of the document to a first document element identifier;
matching a second document element of the document to a second document element identifier; and
upon an association rule determining the first document element identifier is associated with the second document element identifier, chunking the first document element and the second document element into a single chunk of the number of chunks.

3. The method of claim 2, wherein at least one of the first document element identifier and the second document element identifier are determined in accordance with a file type of the document.

4. The method of claim 2, wherein at least one of the first document element identifier and the second document element identifier are determined in accordance with a domain of the document.

5. The method of claim 2, wherein the association rule is selected from a plurality of association rules in accordance with a user-provided intent of the document, and wherein the user-provided intent comprises an association between a number of association rules comprising the association rule.

6. The method of claim 1, wherein the number of chunks is selected in accordance with a maximum chunk size for each of the number of chunks.

7. The method of claim 1, further comprising selecting the resolver from a plurality of resolvers, the selection further comprising providing the document to an artificial intelligence trained to analyze the document and determine therefrom a closest matching resolver, wherein the artificial intelligence is trained to analyze the document comprising a closest domain.

8. A system, comprising:
a network interface to a communication network; and
a microprocessor coupled to a computer memory comprising machine-readable instructions that when read by the microprocessor cause the microprocessor to perform:
accessing a document;
accessing a resolver,
wherein the resolver comprises two or more different resolver types;
chunking the document, in accordance with the resolver, into a number of chunks;
vectorizing the number of chunks into a number of vectorized chunks;
providing, via the network interface, the number of vectorized chunks to a data storage for storage therein;
retrieving the number of vectorized chunks;
receiving a query;
appending the number of vectorized chunks to the query;
providing the query to a large language model; and
receiving a response therefrom.

9. The system of claim 8, wherein the number of chunks is selected in accordance with a maximum chunk size for each of the number of chunks.

10. The system of claim 8, wherein the microprocessor further performs selecting the resolver from a plurality of resolvers, the selection further comprising providing the document to an artificial intelligence trained to analyze the document and determine therefrom a closest matching resolver, wherein the artificial intelligence is trained to analyze the document comprising a closest domain.

11. The system of claim 8, wherein the microprocessor performs chunking the document, in accordance with the resolver, into the number of chunks, further comprising:
matching a first document element of the document to a first document element identifier;
matching a second document element of the document to a second document element identifier; and
upon an association rule determining the first document element identifier is associated with the second document element identifier, chunking the first document element and the second document element into a single chunk of the number of chunks.

12. The system of claim 11, wherein at least one of the first document element identifier and the second document element identifier are determined in accordance with a file type of the document.

13. The system of claim 11, wherein at least one of the first document element identifier and the second document element identifier are determined in accordance with a domain of the document.

14. The system of claim 11, wherein the association rule is selected from a plurality of association rules in accordance with a user-provided intent of the document, and wherein the user-provided intent comprises an association between a number of association rules comprising the association rule.

15. The system of claim 11, further comprising:
a user interface; and
wherein the microprocessor further performs:
receiving user inputs via the user interface to construct a template,
wherein the template associates at least one of a first training document element to the first document element identifier or a second training document element to the second document element identifier; and
storing the template as the resolver.

16. The system of claim 15, further comprising receiving a user input comprising an intention.

17. The system of claim 16, wherein the microprocessor further performs:
receiving a second query via the user interface; and
matching the second query to the intention and, in response, appending the number of vectorized chunks associated with the single chunk to the template stored as the resolver.

18. The system of claim 16, wherein the microprocessor further performs:
receiving a second query via the user interface; and
failing to match the second query to the intention and, in response, appending the number of vectorized chunks associated with at least one of content or semantics to the template stored as the resolver.

19. (canceled)

20. A non-transitory computer-readable media comprising instructions that, when read by a microprocessor, cause the microprocessor to perform:
accessing a document;
accessing a resolver,
wherein the resolver comprises two or more different resolver types;
chunking the document, in accordance with the resolver, into a number of chunks;
vectorizing the chunks into a number of vectorized chunks;
providing the number of vectorized chunks to a data storage for storage therein;
retrieving the number of vectorized chunks;
receiving a query;
appending the number of vectorized chunks to the query;
providing the query to a large language model; and
receiving a response therefrom.

21. The non-transitory computer-readable media of claim 20, wherein the number of chunks is selected in accordance with a maximum chunk size for each of the number of chunks.
